(19) United States
(12) Patent Application Publication
(10) Pub. No.: US 2007/0133212 A1
(43) Pub. Date: Jun. 14, 2007

(54) Illuminating device

(75) Inventors: Wan-Chun Lin, Taipei (TW); Tzy-Chang Tan, Taipei (TW); Kun-Han Hsieh, Taipei (TW); Kai-Chi Chang, Taipei (TW)

Correspondence Address: BAKER & MCKENZIE LLP;PATENT DEPARTMENT, 2001 ROSS AVENUE, SUITE 2300, DALLAS, TX, 75201, US

(73) Assignee: UPEC Electronics Corp.

(21) Appl. No.: 11/356,727

(22) Filed: Feb. 17, 2006

(30) Foreign Application Priority Data
Dec. 8, 2005 (TW) 094221359

(51) Int. Cl. F21V 7/00

(52) U.S. Cl. 362/341

(57) ABSTRACT

An illuminating device equipped with an integrated one-piece transparent shell is provided according to one embodiment of the invention. The illuminating device may be connected to a television, a computer monitor or an audio apparatus such that the illuminating device projects ambient light onto background walls or surroundings in order to improve the comfort and viewing experience. In one embodiment of the invention, an illuminating device used for ambient light comprises: a circuit unit comprising a plurality of light sources emitting light and a transceiver accepting display information; a shell coupled with said circuit unit; wherein a portion of said shell is transparent; wherein the shell comprises a diffusion portion and a reflection portion, and wherein a portion of said emitted light is reflected by said reflection portion and dispersed by said diffusion portion.

### CROSS-REFERENCE TO RELATED APPLICATION

This application is based on Taiwanese Patent Application No. 094221359 filed Dec. 8, 2005 including specification, claims, drawings and summary. The disclosure to the above Taiwanese patent application is incorporated herein by reference in its entirety.

### FIELD OF THE INVENTION

The present invention generally relates to light sources, and more specifically certain embodiments of the present invention relate to light sources that provide concentrated light to an ambient environment. Such light sources may be used as a backlight for computer monitors, televisions, and audio apparatuses.

### BACKGROUND OF THE INVENTION

Televisions and computer monitors utilize flat panels and digital techniques to improve dimensional size and display quality, and many more improvements are still under development, such as 3D digital comb filters and 3D digital noise reduction. Recently, research and development efforts for display apparatus are directed towards the outside environment of the display apparatus and the use of light sources to project ambient light to the outside environment, e.g., the walls around the display apparatus.

Ambient light creates a comfortable atmosphere around the viewers such that the viewers can be immersed in the visual effect of the display apparatus. For example, if the display apparatus is displaying an ocean and a beautiful beach, then a sky blue light can be projected on the back wall behind the display apparatus. The viewers can thus not only enjoy the image shown on the display apparatus but also feel the ambient environment created by the ambient light source.

The ambient environment created by the ambient light sources can be dynamic, too. If a video on a television portrays a thunderstorm, then a rainy and dark environment may be created by the ambient light sources. When lightning or thunder strikes suddenly in the video, a flash can be shown in the surroundings or against the wall behind the television, giving the audience the feeling of being in the stormy rain without a shield. Therefore, the ambient light sources cast appropriate light or images in the surroundings or the walls behind the television according to the content of the video in a dynamic and time varying manner.

It is natural that the lighting of a restaurant or a coffee shop is specifically designed to be incorporated into the aura which the restaurant or the coffee shop wishes to offer visiting customers. Moreover, music is also an essential element for constructing such a comfortable place. It is often that the lighting design of a shop is fixed such that the music is necessarily chosen to be in accord with the lighting design. However, the concept of the ambient light provides another choice for these applications. For example, an audio apparatus may extract the rhythm of melodies and further project appropriate lighting into the surroundings through several ambient light sources.

Another example of the need for an ambient light source may occur when the screen size of a television does not cover the whole wall in front of viewers, such that the viewers must concentrate and focus on the small display screen. In such cases, the viewers' eyes need to adjust themselves frequently between the brightness of the images shown on the display screen and the different brightness of the environment. This makes the eyes physically tired and is stressful. The ambient light technique can soften the difference in brightness between the display screen and the outside environment so that the audience does not need to adjust between different regimes.

A prior art illuminator disclosed in U.S. Pat. No. 5,255,171 to L. Douglas Clark entitled “Colored light source providing intensification of initial source illumination,” provides an illuminating device utilizing light emitting diodes (“LED”) as light sources and a reflector with parabolic reflecting walls. The illuminating device further comprises a diffuser attached to one end thereof and LEDs positioned at the base which is the opposite end thereof. However, this disclosure mainly focuses on a light concentrator for use with a color optical scanning device, such as line scanning imaging systems and area scan imaging systems. Utilizing LEDs as light sources is gradually gaining popularity and in particular with respect to their use as light sources of lamps. As the luminosity of LEDs has improved greatly, they are replacing traditional lamps equipped with filaments or fluorescent light.

Unlike normal lamps with LEDs as light sources, it is desirable for light sources for projecting ambient light into the environment or against the walls behind a display apparatus to be carefully designed. A suitable light source for projecting ambient light considers factors including light transmittance, mixture of different color LEDs, response time of the LEDs, orientation of light projecting, reflectivity of light, etc. Furthermore, it is also important to physical combine such ambient light sources with a display apparatus or an audio apparatus since the industrial design of an audio-video (“AV”) apparatus plays a role in acceptance by customers.

### SUMMARY OF THE INVENTION

Therefore, one aspect of the present invention is to provide an ambient light source providing an AV apparatus to generate a more comfortable environment for users.

According to one embodiment of the present invention, an illuminating device for ambient light comprises: a circuit unit comprising a plurality of light sources and a transceiver accepting display information; a shell coupled with said circuit unit; wherein a portion of said shell is transparent; wherein the shell comprises a diffusion portion and a reflection portion; and wherein a portion of said emitted light is reflected by said reflection portion and dispersed by said diffusion portion. According to another embodiment of the present invention, the shell comprises a diffusion portion and a reflection portion integrated into a single piece. Optionally, the transceiver may utilize either a serial communication protocol or a parallel communication protocol. According to another embodiment of the present invention, the transceiver can be configured to communicate with a display or audio apparatus using pulse width modulation (PWM) signals.

In one aspect of the invention, the display information may be extracted from a portion of at least one image or a portion of rhythm of at least one melody. The display information gathered by the transceiver may be used to control the light sources to distribute lights in a time-varying manner or spread in space. The light sources may employ LEDs. Moreover, the light sources may contain three primary colors such that more mixed colors may be created and displayed.

In another aspect of the invention, the diffusion portion may comprise a frosted surface or a light diffuser sheet. The reflection portion may comprise a reflecting layer wherein the reflecting layer can be coated with oil film or electroplated with at least one metal layer. Furthermore, the reflection portion may comprise an embedded reflecting layer to avoid oxidation, which occurred in the prior art when a metal layer was used. With the reflecting layer embedded, deformation of the reflecting layer can also be avoided.

In another aspect of the invention, a reflecting plate may be coupled with the open mouth of the shell for increasing the light reflected toward the diffusion portion. The shell may further comprise a shelter for covering the upper surface of the circuit unit not covered by the diffusion portion.

According to another embodiment of the invention, an illuminating device used for ambient light comprises: a circuit unit comprising a plurality of light sources emitting light and a transceiver accepting display information; a separable shell coupled with said circuit unit; wherein a portion of said shell is transparent; wherein the separable shell comprises a diffusion portion and a reflection portion; and wherein a portion of said emitted light is reflected by said reflection portion and dispersed by said diffusion portion.

According to another embodiment of the invention, an illuminating device used for ambient light comprises: a circuit unit comprising a plurality of light sources emitting light and a transceiver accepting display information; a separable shell coupled with said circuit unit; wherein a portion of said shell is transparent; wherein the separable shell comprises a diffusion portion and a reflection portion; wherein said diffusion portion is separable from said reflection portion; and wherein a portion of said emitted light is reflected by the reflection portion and dispersed by the diffusion portion.

### BRIEF DESCRIPTION OF THE DRAWINGS

Various objects and advantages of certain embodiments of the present invention will be more readily understood from the following detailed description when read in conjunction with the appended drawings, in which like reference numerals designate like parts throughout the figures thereof and wherein:

FIG. 1A is a perspective view illustrating an illuminating device L1 according to an embodiment of the present invention;

FIG. 1B is an exploded perspective view of the illuminating device L1 in FIG. 1A;

FIG. 1C shows an optional implementation of a reflective portion I in FIG. 1B according to one embodiment of the invention;

FIG. 1D shows another optional implementation of a reflective portion II in FIG. 1B according to one embodiment of the invention;

FIG. 1E shows an illuminating device L1′ modified from the previous embodiment of the invention;

FIG. 2A is a perspective view illustrating an illuminating device L2 according to one embodiment of the present invention;

FIG. 2B is an exploded perspective view of the illuminating device L2 in FIG. 2A;

FIG. 2C shows an optional implementation of a reflective portion I′ in FIG. 2B according to one embodiment of the invention;

FIG. 2D shows another optional implementation of a reflective portion II′ in FIG. 2B according to one embodiment of the invention;

FIG. 3A is a perspective view illustrating an illuminating device L3 according to one embodiment of the present invention;

FIG. 3B is an exploded perspective view of the illuminating device L3 in FIG. 3A;

FIG. 3C shows an illuminating device L3′ modified from the previous embodiment of the invention;

FIG. 4A is a perspective view illustrating an illuminating device L4 according to one embodiment of the present invention;

FIG. 4B is an exploded perspective view of the illuminating device L4 in FIG. 4A; and

FIG. 4C shows an illuminating device L4′ modified from the previous embodiment of the invention.

### DESCRIPTION OF EMBODIMENTS OF THE INVENTION

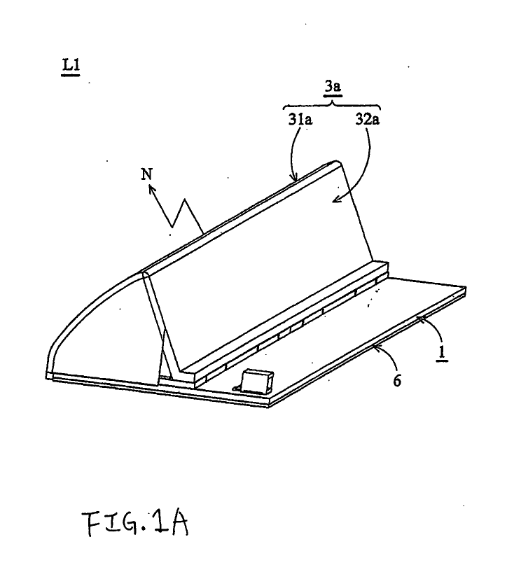

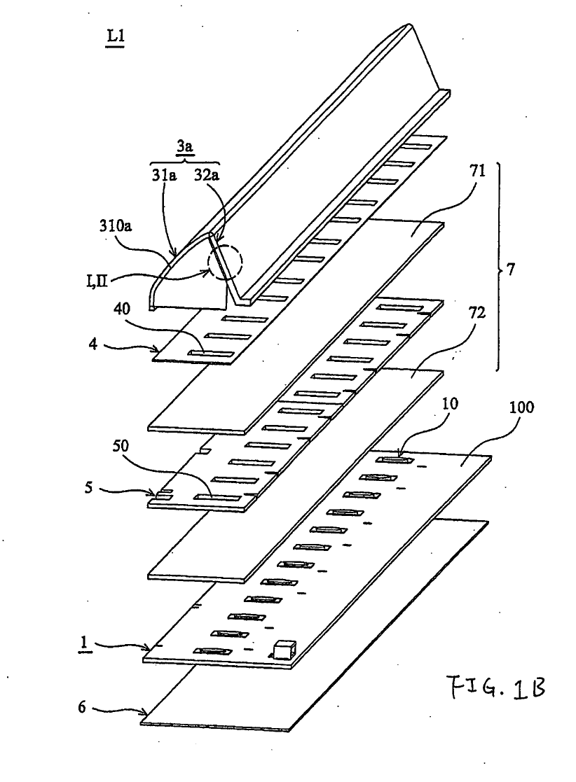

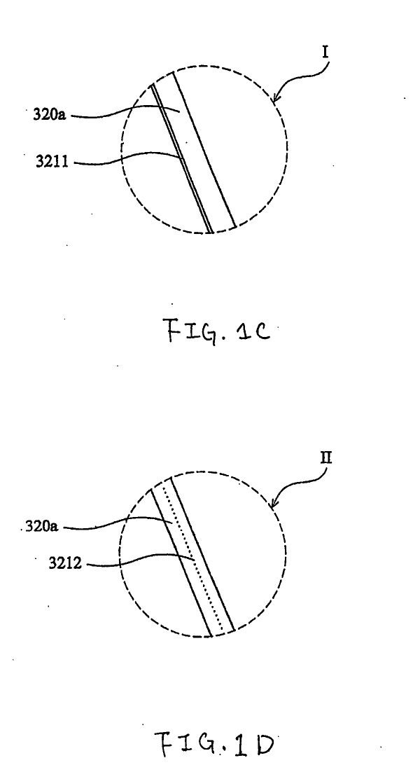

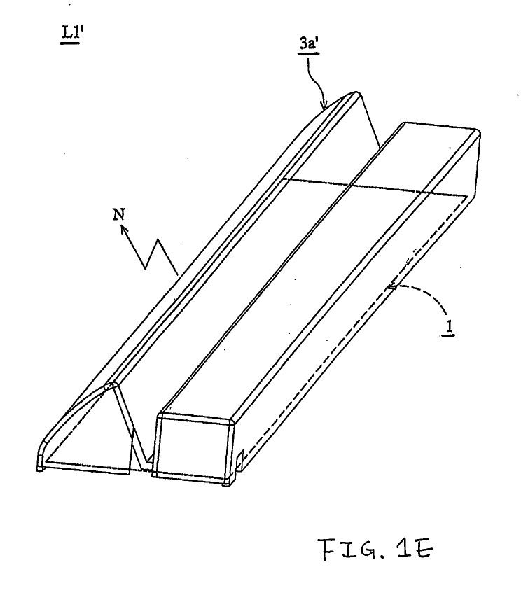

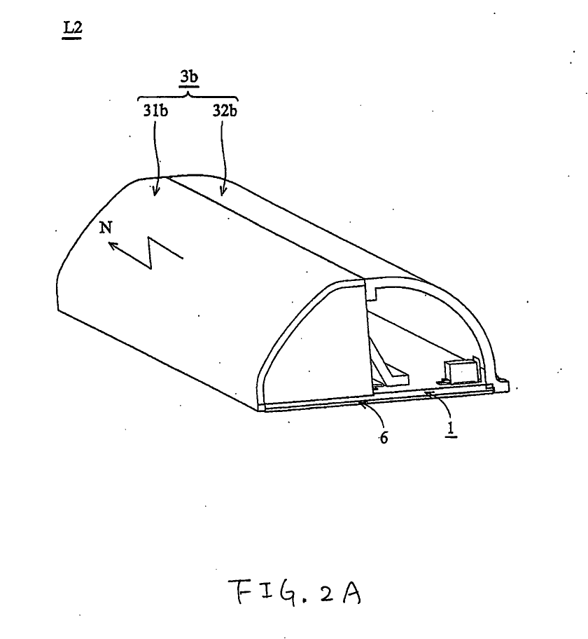

FIG. 1A is a perspective view illustrating an illuminating device L1 comprising a circuit unit 1 on which at least one light source is attached, and a transparent shell 3a, according to one embodiment of the present invention. In one embodiment, the illuminating device L1 comprises a circuit unit 1, a transparent shell 3a and a heat sink plate 6 attached to the circuit unit 1. The circuit unit 1 may further comprise an appropriate number of LEDs soldered to its upper surface. The transparent shell 3a comprises a diffusion portion 31a and a reflection portion 32a. The heat sink plate 6 is made of a material that can efficiently dissipate heat, generated mainly by the LEDs soldered on the circuit unit 1, while projecting light, reflected by the reflection portion 32a of the transparent shell 3a, along a desirable direction N through the diffusion portion 31a of the transparent shell 3a. According to an embodiment of the present invention, the illuminating device L1 may be connected to a display apparatus, e.g., a television or a computer monitor, or an audio apparatus, e.g., a stereo CD player. The illuminating device L1 can be configured to receive a signal related to (a) the images or video shown on the display apparatus or (b) the rhythm or melodies output by the stereo CD player, through an appropriate protocol which may include serial communication or parallel communication. In one embodiment, the illuminating device L1 includes a transceiver (not shown), mounted on the circuit unit 1, that receives display information, including a Pulse Width Modulation (PWM) signal, from the display apparatus or the audio apparatus. The display apparatus or audio apparatus may be configured to extract a portion or all of (a) the images on the display apparatus or (b) the rhythm or melodies output by the audio apparatus, convert it into a digital or analog signal, and send it to the transceiver as a PWM signal.

FIG. 1B is an exploded perspective view of the illuminating device L1 in FIG. 1A, where all numerals correspond to those elements previously described. In one embodiment, the illuminating device L1 comprises a circuit unit 1, a transparent shell 3a and a heat sink plate 6. The circuit unit 1 comprises a print circuit board (PCB) 100 and a plurality of light sources 10. In one embodiment, the circuit unit 1 is equipped with light sources 10 utilizing filaments or fluorescent light, provided that the light sources 10 have enough luminosity and quick response time. The light sources 10 may have different colors, e.g., red, green, and blue, such that more mixed colors can be obtained by coordinating a small number of primary colors distributed over time or spread in space. Moreover, the illuminating device L1 may further comprise an external power source (not shown) to provide power from an external display apparatus or audio apparatus and data lines (not shown) communicating with said external display apparatus or audio apparatus.

The transparent shell 3a comprises a diffusion portion 31a and a reflection portion 32a as shown in FIG. 1B. The transparent shell 3a is made of transparent materials, e.g., glass. There are many other transparent materials that can be used to make the transparent shell 3a. For example, a translucent plastic, resin or polymer can also be used to manufacture the transparent shell 3a. Therefore, depending on the flexibility properties of the materials used, the transparent shell 3a can have an integrated one-piece construction that performs functions including reflection and diffusion. From the axial view, the longer sides of the transparent shell 3a can appear to have a “V” shape. In one embodiment, the diffusion portion 31a allows at least 85% of the original light from the light sources 10 to pass through, and more preferably, the diffusion portion 31a allows at least 90% of the original light from the light sources 10 to pass through.

The diffusion portion 31a, which can be an integrated portion of the transparent shell 3a, comprises a transparent body 310a with a frosted surface or covered with a light diffuser sheet (not shown) giving an uniform distribution of light exiting the diffusive portion 31a. The reflection portion 32a, also an integrated portion of the transparent shell 3a, comprises a transparent body 320a and an additional reflecting layer I or II for reflecting light emitted from the light sources 10 and guiding the reflected light on the track to the diffusion portion 31a. Several options for implementing the reflecting layer I or II will be explained later in FIG. 1C and FIG. 1D.

The heat sink plate 6 in FIG. 1B for dissipating heat generated from the light sources 10 on the PCB 100 can be made of metal materials and coupled with the PCB 100. Such metal materials can include copper, aluminum, tin, etc. Between the solid components, e.g., the PCB 100 and the transparent shell 3a, it is desirable to have an additional soft layer 5 inserted for protecting the solid components from shock or friction. The soft layer 5 can be made of sponge or other soft materials able to isolate humidity from the outside and to buffer impact or harm between the PCB 100 and the transparent shell 3a. According to one embodiment of the present invention, the illuminative device L1 can include a plurality of openings 50 over the light sources 10 to pass light emitted from the light sources 10. According to another embodiment of the present invention, there can be at least one additional adhesive layer 7, comprising adhesive layers 71 and 72, to adhere the soft layer 5 with the transparent shell 3a and the PCB 100 respectively. The adhesive layers 71, 72 may have various forms and do not necessarily cover the entire surface of the soft layer 5. The adhesive layers 71, 72 can be tape, glue or secured by nuts and bolts, screws or welding. Furthermore, the adhesive layers 71, 72 may be omitted if inward lips located along the edges of the transparent shell 3a are provided such that the transparent shell 3a and other components can be secured together.

A reflective plate 4 with a plurality of openings 40 may be inserted between the transparent shell 3a and the PCB 100 to reflect more light in the direction N as shown in FIG. 1A. The reflective plate 4 may be a plate with white color or a plastic sheet coated with silver. Therefore, the light directed in direction N can be reflected from the reflection portion 32a of the transparent shell 3a, from the reflective plate 4, and so on.

FIG. 1C and FIG. 1D illustrate two examples of the reflective portion 32a. FIG. 1C illustrates the reflective portion I in FIG. 1B. According to one embodiment, the reflective portion I may comprise a transparent body 320a if the transparent shell 3a can be made as a single integrated piece and perform the functions of reflection and diffusion. The reflective portion I may alternatively comprise a non-transparent body 320a if necessary. A reflective layer 3211 may be coated with oil film or electroplated with metal or foil on the transparent body 320a such that light from light sources 10 can be reflected by the reflective layer 3211 and forced into the direction N through the diffusion portion 31a of the transparent shell 3a.

According to another embodiment of the present invention, FIG. 1D illustrates the reflective portion II in FIG. 1B. The reflective portion II comprises a transparent body 320a and a reflective layer 3212 wherein the reflective layer 3212 is embedded in the transparent body 320a. The reflective layer 3212 can be embedded during the manufacturing process of the integrated one-piece transparent shell 3a. With the protection of the transparent body 320a, the reflective layer 3212 is free from the oxidation and deformation typical to metal reflective layer coatings.

According to one embodiment of the present invention, a method for displaying ambient light comprises: first, the illuminating device L1 receiving color information via the circuit unit 1 from a television or audio apparatus, through a communication protocol which may be serial or parallel. The color information comprises a plurality of digital signals extracted from images shown on the screen of the television or from the rhythm output by the audio apparatus. Second, the circuit unit 1 drives and ignites the light sources 10, e.g., LEDs, according to the color information extracted from the images or rhythm of the external television or audio apparatus. Thus, provided that there are LEDs with multiple colors, emitted light of different colors is projected outwardly from the light sources 10. Third, the emitted light, through the openings 50 and 40, is further reflected by the reflective portion 32a and the reflective plate 4, and forced into the direction N. Fourth, the reflected light along the direction N is scattered by the diffusion portion 31a of the transparent shell 3a to increase the luminance uniformity and avoid partial deterioration in light transmittance. Finally, uniform lights are projected on the background wall or surroundings in accord with the images shown on the television or rhythms output by the audio apparatus.

Because the appearance of the projected light shown on the background walls or surroundings is affected by the spatial dimensions of the lit surface(s), it may be desirable to make various adjustments according to the external environment. The invention is not limited to light sources positioned in a straight line, rather other embodiments of the present invention may comprise a plurality of light sources distributed in various patterns across the PCB board, provided that the projected light on the background walls or surroundings is uniform. Moreover, the invention may be an illuminating device with an “L” shape or other non-linear form. The physical structure of the illuminating device can be designed according to the physical structure of a television or audio apparatus, so variations and modifications in shape and structure are possible. Other variations may be made for packages of light sources. For example, a package containing a red, green, and blue LED is possible. The illuminating device of the invention may employ packages containing LEDs with other colors.

FIG. 1E shows an illuminating device L1′ modified from the device L1 in the previous embodiment of the invention. In another embodiment of the present invention, a transparent shell 3a′ of the illuminating device L1′ further comprises a shelter portion covering the exposed area on the circuit unit 1 in FIG. 1A. This improvement increases the reliability of the circuit unit 1 in FIG. 1A and protects the circuit unit 1 from dust, water, etc. The shelter portion of the transparent shell 3a′ may be a separable component or an integrated potion of the transparent shell 3a′.

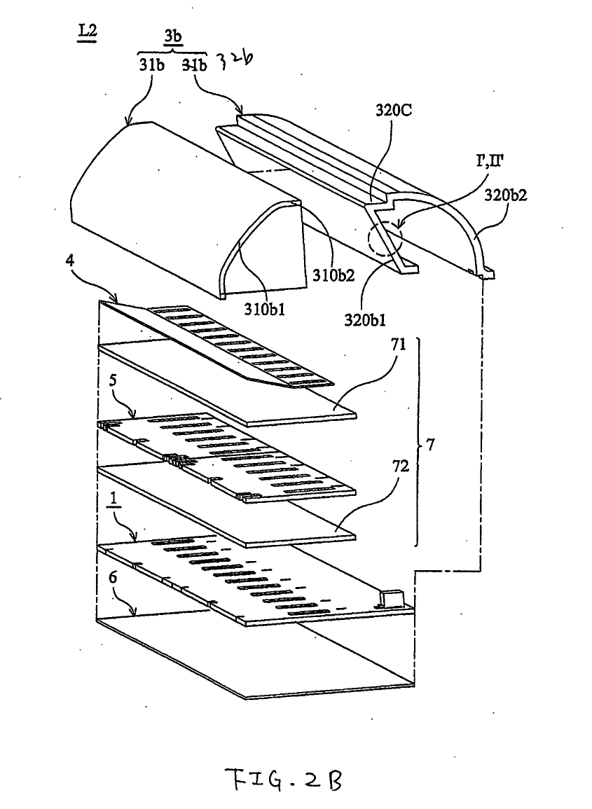

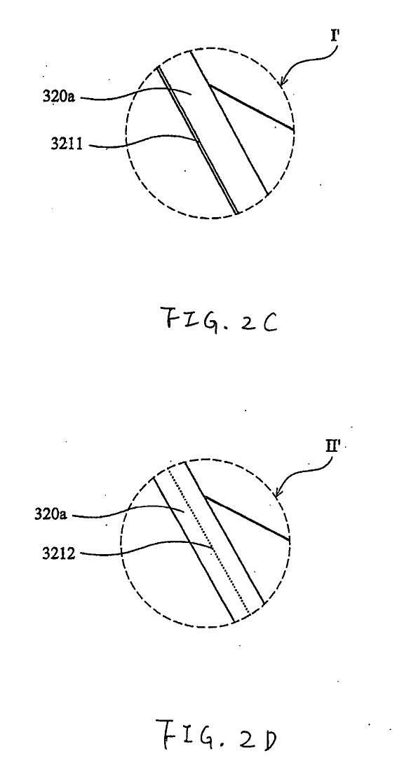

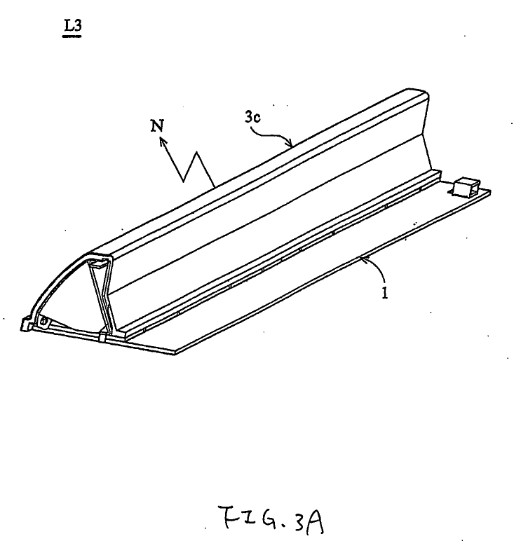

FIG. 2A is a perspective view illustrating an illuminating device L2 according to another embodiment of the present invention. The illuminating device L2 comprises a circuit unit 1, a shell 3b with a separable diffusion portion 31b and a reflection portion 32b, and a heat sink plate 6. In this figure, like reference numerals designate like parts in the previous figures. The direction N represents the direction of the light emitted from the illuminating device L2. The difference between the illuminating device L2 and the illuminating device L1 is that the shell 3b is separable. Therefore, the reflection portion 32b may be made of non-transparent materials. The components of the illuminating device L2 can be easily manufactured.

FIG. 2B is an exploded perspective view of the illuminating device L2 in FIG. 2A. More details about the separable portions 31b and 32b are illustrated in this figure. The diffusion portion 31b may comprise a diffusion surface 310b1 and a lip 310b2 located along the upper edges of the diffusion portion 31b, which allows for alignment of the reflection portion 32b. The reflection portion 32b may comprise a reflective layer 320b1, a shelter part 320b2 and a recess 320C located along the border between the reflective layer 320b1 and the shelter part 320b2 wherein the recess 320C couples with the lip 310b2 of the diffusion portion 31b. The diffusion portion 31b can be made of transparent materials, e.g., glass. There are many other transparent materials that can be used to make the diffusion portion 31b. For example, a translucent plastic, resin or polymer can also be used to manufacture the diffusion portion 31b. For another example, the diffusion surface 310b1 may be coated with a diffusion layer on the outward surface or frosted.

According to other embodiments of the present invention, the reflective layer 320b1 of the reflection portion 32b may comprise I′ or II′ to perform reflection similar to the examples mentioned in FIGS. 1C and 1D. In FIGS. 2C and 2D, like reference numerals designate like parts in the FIGS. 1C and 1D. In the first example, I′ may comprise a transparent body 320a and a reflective layer 3211. Alternatively, I′ may employ a non-transparent body, since the reflection portion 32b is separable and therefore it is not necessary to use the same material used by the diffusion portion 31b. In the second example, II′ may comprise a transparent body 320a and an embedded reflective layer 3212. Likewise, II′ may alternatively employ a non-transparent body.

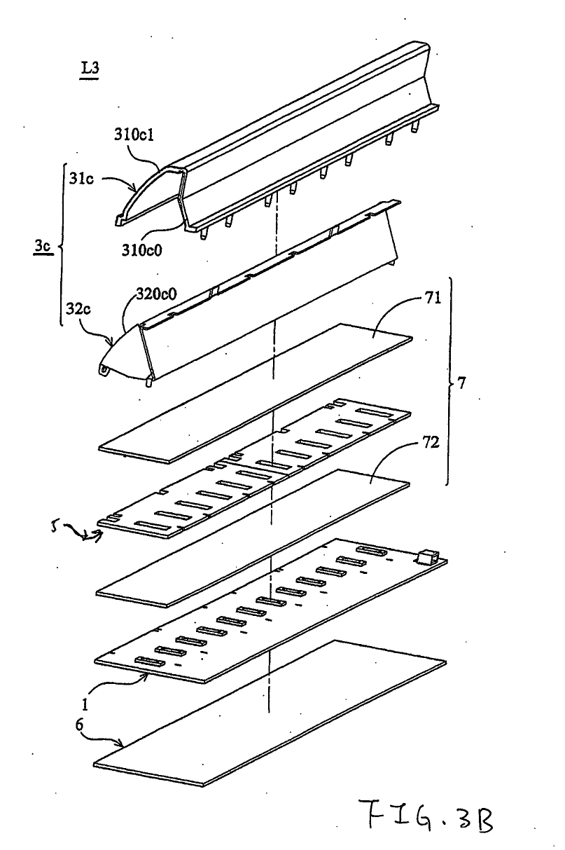

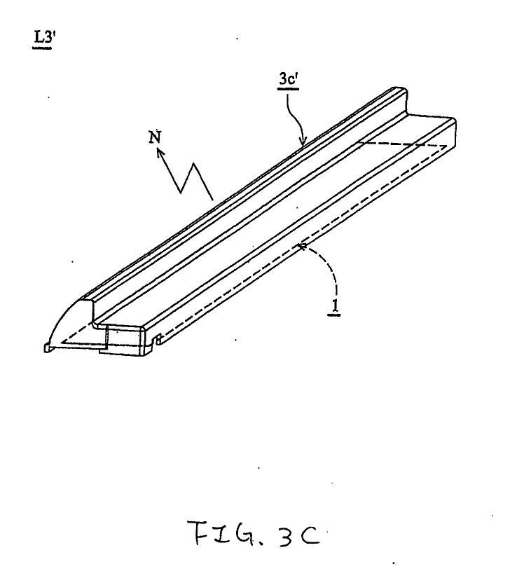

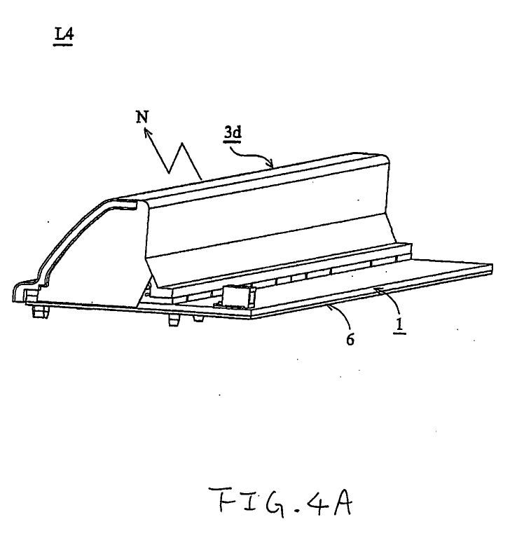

FIG. 3A is a perspective view illustrating an illuminating device L3 according to another embodiment of the present invention. The illuminating device L3 comprises a circuit unit 1, a shell 3c comprising a separable diffusion portion 31c and a reflection portion 32c, and a heat sink plate 6. In this figure, like reference numerals designate like parts in the previous figures. The direction N represents the direction of the light emitted from the illuminating device L3. The difference between the illuminating device L3 and the illuminating device L1 is that the reflection portion of the shell 3c is separable.

FIG. 3B is an exploded perspective view of the illuminating device L3 in FIG. 3A. In FIG. 3B, like reference numerals designate like parts in the FIG. 1B. The diffusion portion 31c may comprise a diffusion surface 310c1 and a supportive body 310c0 wherein the diffusion surface 310c1 and the supportive body 310c0 are made as an integrated one-piece object. The diffusion portion 31c may be made of transparent materials, e.g., glass. There are many other transparent materials that can be used to make the diffusion portion 31c. For example, a translucent plastic, resin or polymer can be used to manufacture the diffusion portion 31c. For another example, the diffusion surface 310c1 may comprise a frosted material or a diffusion layer coated on the outward surface. The diffusion portion 31c may include a recess along the lower edge to accommodate the front edge of the PCB of the circuit unit 1. From the horizontal axis, the sectional view of the diffusion portion 31c may be in a “V” shape such that the mouth thereof receives the reflection portion 32c and the circuit unit 1. Furthermore, the supportive body 310c0 may comprise a plurality of pegs or tabs for insertion into corresponding holes on the PCB of the circuit unit 1.

From the horizontal axis, the sectional view of the reflection portion 32c may be in a “V” shape, the mouth 320c0 of which receives the diffusion surface 310c1. In one embodiment of the present invention, the upper edge of the reflection portion 32c may comprise segmented lips and recesses, so that the reflection portion 32c can be secured firmly with the diffusion portion 31c. Moreover, the reflection portion 32c may comprise a plurality of openings (not shown) in the lower surface of the reflection portion 32c against the mouth of the diffusion portion 31c, for the emitted light to pass through.

The reflection portion 32c may be made of metal materials, e.g., aluminum, or resin with white color. Since the reflection portion 32c contains two flat surfaces, light emitted from the light sources can be reflected from either surface and forced into the direction N in FIG. 3A.

FIG. 3C shows an illuminating device L3′ modified from the device L3 in the previous embodiment of the invention. According to another embodiment of the present invention, a transparent shell 3c′ of the illuminating device L3′ further comprises a shelter portion covering the exposed area of the circuit unit 1 in FIG. 3A. This increases the reliability of the circuit unit 1 in FIG. 3A and protects the circuit unit 1 from dust, water, etc. The shelter portion of the transparent shell 3c′ may be a separable component or an integrated potion thereof.

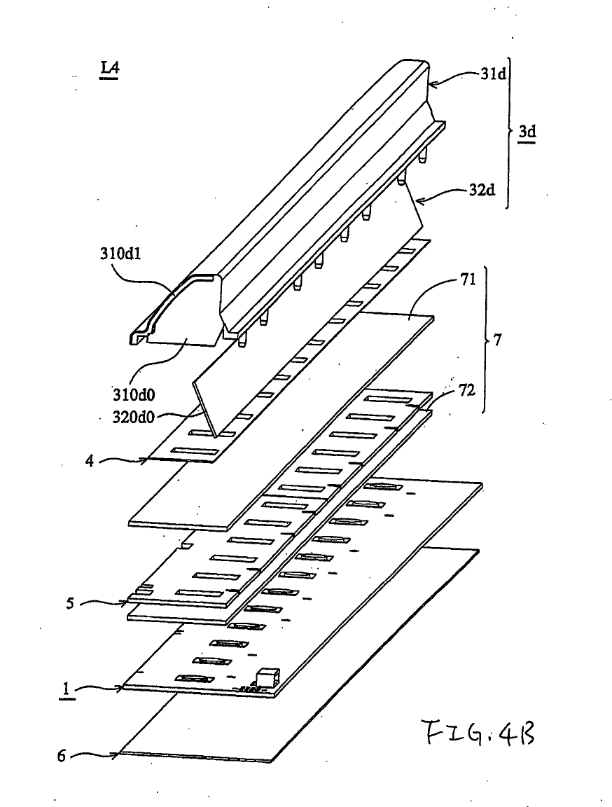

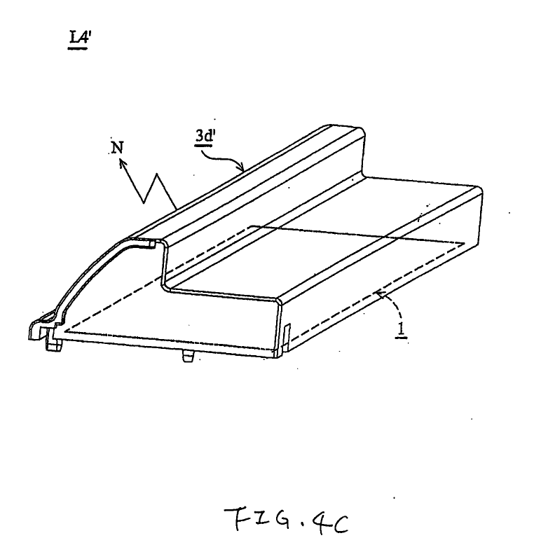

FIG. 4A is a perspective view illustrating an illuminating device L4 according to another embodiment of the present invention. The illuminating device L4 may comprise a circuit unit 1, a shell 3d comprising a separable diffusion portion 31d and a reflection portion 32d (shown in FIG. 4B), a reflective plate 4 and a heat sink plate 6. In this figure, like reference numerals designate like parts in the previous figures. The direction N represents the direction of the light emitted from the illuminating device L4. The difference between the illuminating device L4 and the illuminating device L1 is that the reflection portion of the shell 3d is separable.

FIG. 4B is an exploded perspective view of the illuminating device L4 in FIG. 4A. In FIG. 4B, like reference numerals designate like parts in the FIG. 1B. According to another embodiment of the present invention, the diffusion portion 31d further comprises a diffusion surface 310c1. The diffusion portion 31d may be made of transparent materials, e.g., glass. There are many other transparent materials that can be used to make the diffusion portion 31d, such as a translucent plastic, resin, or polymer. The diffusion surface 310d1 may be a diffusion layer coated on the outward surface thereof or a frosted material such as frosted glass. The diffusion portion 31d may include a recess along the lower edge to accommodate the front edge of the PCB of the circuit unit 1. From the horizontal axis, the sectional view of the diffusion portion 31d may be in a “V” shape such that the mouth 310d0 receives the reflective plate 4 and the circuit unit 1. Furthermore, the diffusion portion 31d may comprise a plurality of tabs or pegs for insertion into corresponding holes on the PCB of the circuit unit 1.

The reflection portion 32d may be a metal plate, e.g., an aluminum plate, a plastic plate coated with a reflective layer 320d0, or a white plastic plate. The diffusion portion 31d may comprise a recess to accommodate the upper edge of the reflection portion 32d so that the reflection portion 32d can be secured firmly.

FIG. 4C shows an illuminating device L4′ modified from the device L4 in the previous embodiment of the invention. In another embodiment of the present invention, a transparent shell 3d′ of the illuminating device L4′ further comprises a shelter portion covering the exposed area on the circuit unit 1 in FIG. 4A. This increases the reliability of the circuit unit 1 in FIG. 4A and protects the circuit unit 1 from dust, water, etc. The shelter portion of the transparent shell 3d′ may be a separable component or an integrated potion thereof.

It is to be understood that these embodiments are not meant as limitations of the invention but merely exemplary descriptions of the invention with regard to certain specific embodiments. Indeed, different adaptations may be apparent to those skilled in the art without departing from the scope of the claims. For instance, the arrangement of the light sources may be adjusted according to external environments or in order to adapt the device to a specific video or audio apparatus. Moreover, the shape of the illuminating devices is not limited to a bar form. An illuminating device with an “L” shape, combinations of bars, or other non-linear structure is also possible.

What is claimed is:

1. An illuminating device, comprising:
at least one light source; and
a shell unit to force light emitted from said light source toward a predetermined direction.

2. The illuminating device of claim 1, wherein the shell unit allows at least 85 percent of the light emitted from the light sources to pass through.

3. The illuminating device of claim 1, further comprising:
a circuit unit electrically coupled with the light source.

4. The illuminating device of claim 1, wherein the shell unit further comprises a diffusion portion to force light emitted from said light source toward a predetermined direction.

5. The illuminating device of claim 1, wherein the shell unit further comprises a diffusion portion and a reflection portion to reflect light emitted from said light source toward the diffusion portion.

6. The illuminating device of claim 5, wherein the reflection portion comprises a reflective surface to reflect light emitted from said light source toward the diffusion portion.

7. The illuminating device of claim 6, wherein the reflecting surface is an oil film.

8. The illuminating device of claim 6, wherein the reflecting surface is an electroplated film.

9. The illuminating device of claim 5, wherein the reflection portion comprises a body and a reflecting film integrated into one piece.

10. The illuminating device of claim 9, wherein the body is made of resin.

11. The illuminating device of claim 9, wherein the reflecting film is made of a reflective material.

12. The illuminating device of claim 9, wherein the diffusion portion and the reflection portion are integrated into one piece.

13. The illuminating device of claim 5, further comprising:
a reflecting plate positioned between the diffusion portion and the circuit unit.

14. The illuminating device of claim 5, further comprising:
a soft layer positioned between the diffusion portion and the circuit unit.

15. The illuminating device of claim 14, wherein the soft layer is a sponge.

16. The illuminating device of claim 5, further comprising:
a soft layer; and
an adhesive layer to adhere said soft layer with the diffusion portion and the circuit unit.

17. The illuminating device of claim 1, further comprising:
a heat sink plate attached on the circuit unit.

18. The illuminating device of claim 5, wherein the reflection portion is made of a metal.

19. The illuminating device of claim 18, wherein the metal is aluminum.

20. The illuminating device of claim 5, wherein the reflection portion is made of resin.

21. The illuminating device of claim 20, wherein the resin is white.

22. The illuminating device of claim 1, wherein the shell unit shields the circuit unit.

23. An illuminating device for ambient light, comprising:
a circuit unit comprising a plurality of light sources emitting light and a transceiver accepting display information;
a shell unit coupled with said circuit unit, wherein a portion of said shell unit is transparent;
wherein the shell unit further comprises a diffusion portion and a reflection portion; and
wherein a portion of said emitted light is reflected by said reflection portion and dispersed by said diffusion portion.

24. The illuminating device of claim 23, further comprising:
a heat sink plate attached to the circuit unit.

25. The illuminating device of claim 23, wherein the diffusion portion allows at least 85 percent of the emitted light from the light sources to pass through.

26. The illuminating device of claim 23, wherein the transceiver utilizes a serial communication protocol.

27. The illuminating device of claim 23, wherein the transceiver utilizes a parallel communication protocol.

28. The illuminating device of claim 23, wherein the transceiver communicates with a display or audio apparatus using pulse width modulation signals.

29. The illuminating device of claim 23, wherein the display information is extracted from a portion of at least one image or a portion of at least one rhythm or melody.

30. The illuminating device of claim 23, wherein the light sources comprise at least one light emitting diode.

31. The illuminating device of claim 23, wherein the light sources comprise three primary colors variably displayed over time or based on location.

32. The illuminating device of claim 23, wherein the shell unit is made of a transparent material.

33. The illuminating device of claim 23, wherein the shell unit is a single integrated piece.

34. The illuminating device of claim 23, wherein the shell unit has a “V” shape viewed from the axis along the longer peripheral side thereof.

35. The illuminating device of claim 23, wherein the diffusion portion comprises a frosted surface.

36. The illuminating device of claim 23, wherein the diffusion portion comprises a light diffuser sheet.

37. The illuminating device of claim 23, wherein the reflection portion comprises a reflecting layer.

38. The illuminating device of claim 23, wherein the reflection portion comprises an embedded reflecting layer.

39. The illuminating device of claim 23, wherein the reflection portion is coated with an oil film.

40. The illuminating device of claim 23, wherein the reflection portion comprises an electroplated metal layer.

41. The illuminating device of claim 23, further comprising:
a soft layer inserted between the shell and the circuit unit; and
at least one adhesive layer adhering said soft layer with the circuit unit.

42. The illuminating device of claim 23, further comprising:
a reflecting plate received by an open mouth of the shell unit.

43. The illuminating device of claim 23, wherein the shell unit further comprises a shelter
covering the upper surface of the circuit unit not covered by the diffusion portion and the reflection portion.

44. An illuminating device used for ambient light, comprising:
a circuit unit comprising a plurality of light sources emitting light and a transceiver accepting display information;
a separable shell unit coupled with said circuit unit;
wherein the separable shell comprises a diffusion portion and a reflection portion; and
wherein a portion of said emitted light is reflected by said reflection portion and dispersed by said diffusion portion.

45. The illuminating device of claim 44, wherein the reflection portion comprises an embedded reflecting layer.

46. The illuminating device of claim 44, wherein the reflection portion covers the upper surface of the circuit unit not covered by the diffusion portion.

47. The illuminating device of claim 44, wherein the reflection portion couples the diffusion portion with a recess.
